(19) United States
(12) Patent Application Publication
(10) Pub. No.: US 2025/0256997 A1
(43) Pub. Date: Aug. 14, 2025

(54) Methods and Devices for Collection of Liquid Foams

(71) Applicant: Board of Trustees of Western Michigan University, Kalamazoo, MI (US)

(72) Inventors: Ethan Samuel Coffin, Ann Arbor, MI (US); Donald M Reeves, Kalamazoo, MI (US)

(21) Appl. No.: 18/984,925

(22) Filed: Dec. 17, 2024

Related U.S. Application Data
(60) Provisional application No. 63/634,917, filed on Apr. 16, 2024.
(60) Provisional application No. 63/553,198, filed on Feb. 14, 2024.

(51) Int. Cl. C02F 1/74; C02F 101/36

(52) U.S. Cl. CPC C02F 1/74; C02F 2101/36; C02F 2301/063

(57) ABSTRACT

Embodiments of the present disclosure may include a device for obtaining and collecting foam from a foam-water interface and reducing the liquid content of said foam prior to collection, including one or more rotatable drums, wherein the surface of said one or more drums comprises material that is configured to collect foam from said foam-water interface upon contact of the drum with said interface, and to allow liquid present in the foam to drain through the surface of the drums and reduce the liquid content of the foam as the said one more rotatable drums rotate, and methods of using the same. Some aspects may include collection of enriched foams for surfactant contaminants and compounds such as PFAS in wastewater and other effluent.

### CROSS-REFERENCES TO RELATED APPLICATIONS

This application claims the benefit of U.S. Provisional Application 63/553,198, filed Feb. 14, 2014, and U.S. Provisional Application 63/634,917, filed Apr. 16, 2024. The contents of the aforementioned prior-filed applications are incorporated herein in their entirety.

### BACKGROUND OF THE INVENTION

Per- and polyfluorinated alkyl substances (PFAS) are a family of 10,000+ compounds containing at least one carbon-fluorine bond, widely used in manufacturing, commercial, and consumer products (Buck et al., 2021). PFAS bioaccumulate in plants, animals, and humans, at least some shown to cause adverse reproductive and developmental outcomes, altered immune responses, and cancer at very low concentrations (Fenton et al., 2021). Due to their resistance to degradation and the lack of efficient destructive technologies, PFAS cycle throughout engineered systems until ultimately being released to the natural environment (Stoiber et al., 2020). Wastewater treatment plants (WWTP) passively receive PFAS from landfill leachate as well as municipal and industrial sources and have been identified as key environmental discharge points (Cookson & Detwiler, 2022; Helmer et al., 2022; Lang et al., 2017). WWTP are broadly ineffective at removing PFAS or other recalcitrant compounds, due to their inherent complexity and scale (Dauchy et al., 2017; Lenka et al., 2021; Tavasoli et al., 2021). Therefore, considerable effort is currently being exerted towards researching, developing, and implementing treatment technologies specific to the removal of PFAS from WWTP.

Foam fractionation (FF) is receiving increasing attention as a simple, efficient, and scalable technology to concentrate and remove PFAS from water. FF takes advantage of the surface-active properties of PFAS, owing to competition between the hydrophobic fluorinated tail and hydrophilic functional head group present in most PFAS compounds (Kancharla et al., 2022; Wang et al., 2023; Ziaee et al., 2021). Briefly, previously described methods use compressed air (or another gas), which is introduced at the bottom of the water column, forming bubbles which accumulate surfactants via partitioning to the air-water interface (AWI) of the bubbles as they rise to the water surface. If enough surfactant is present to stabilize the bubble films, a sustained foam will form at the water surface. This foam is concentrated in PFAS relative to the water column and is easily collected, removing significant amounts of PFAS from the water. Longer-chain PFAS have a greater tendency to become enriched in these foams, as they are more surface-active and have a higher affinity for the AWI than shorter-chain PFAS (Buckley et al., 2022). The efficacy of PFAS removal via FF is a complex process dependent on many parameters such as the co-surfactants present (e.g., biopolymers from microorganisms or surfactants present in industrial wastewater), operational conditions of the system, and ionic activity in the foam and wastewater (Buckley et al., 2023; Merz et al., 2011; Vo et al., 2023).

Selective PFAS capture at WWTP presents a unique problem due to large discharge volumes, the complex chemistry in effluent, PFAS concentrations far below their critical micelle concentration, and the variable strength and flow rate of wastewater. Most FF pilot-scale studies are limited to 5-10 L/min, compared to WWTP discharges, which are on the order of several tens to hundreds of millions L/day; further, the impact on FF of variable flow rates and wastewater composition is unknown (Buckley et al., 2022; Smith et al., 2022; Vo et al., 2023).

However, one potential other mitigation measure for PFAS and potentially other surface-active contaminants, is the collection, treatment and disposal of foams that passively form at most WWTP. Foaming at WWTP (especially in secondary aeration tanks) is very common, stimulated by the production of bio-surfactants from filamentous bacteria as well as the presence of manufactured surfactants (Collivignarelli et al., 2020; Palmer & Hatley, 2018). Recently, Schaefer et al. (2023), Smith et al. (2023), and We et al. (2024a) characterized PFAS in foams forming in secondary aeration tanks at WWTP. Enrichment of individual PFAS compounds (e.g., increases in PFAS concentrations in the foam relative to the wastewater) varied by orders of magnitude across these studies. Plant-specific parameters, particularly filamentous bacteria concentration, total suspended solids, and surface tension of the wastewater in the aeration tanks were correlated to PFAS enrichment, however, and may partially explain the wide range of values (We et al., 2024a). Despite this variability, PFAS enrichment in foams generally followed the expected trend of greater enrichment as C-F chain length increased, with concentrations of long-chain PFAS in foam up to 105 times greater than the host wastewater. While these results are promising for using foams to remove PFAS from wastewater, most WWTP would need to be modified to generate enough foam for meaningful PFAS mass removal (Smith et al., 2023), and the efficiency of FF may vary with the scale of the system (Kown, 1971; We et al., 2024b). Therefore, alternative foam-forming processes must be explored to concentrate PFAS and other surfactants more effectively in WWTP.

Cascades can generate foam by entrapping air during shearing between the plunging cascade and the receiving pool (Kister et al., 2023; McKeogh & Ervine, 1981). WWTP often use cascades to aerate wastewater and regulate outfall elevation to avoid backflow from a discharge site (such as a river) into the WWTP system, and these systems may generate foam as an unintended byproduct. Recently, Coffin et al. (2024) collected foam forming at a WWTP cascade with a novel sampling device allowing accurate determination of foam liquid content. PFAS concentrations and enrichment varied widely across different regions of foam and were shown to increase with decreasing liquid content. Coffin et al. (2024) demonstrated that this is due to compound-specific partitioning during foam drainage and collapse, where long-chain PFAS are preferentially retained while short-chain PFAS partition out with the drained fluid.

Scoping calculations suggest the majority of PFOS and other long-chain PFAS may be removed if foam is continuously collected, and this may overcome economic barriers for current destructive technologies, since there is also the potential to reduce the volume of foam waste removed. We et al. (2024b) recently pointed out the need to develop new foam harvesting methods, specific to the geometry and scale of the FF application; these are entirely lacking for cascade systems. This study investigates the feasibility of cascade generated foam collection for PFAS removal at WWTP by iteratively designing and testing three unique continuous foam collection methods. Performance of example aspects and embodiments were determined by quantifying PFAS enrichment factors and foam collection rates. Ultimately, these novel foam collection processes may enhance the performance of cascade FF such that it may be feasible for removal of long-chain PFAS at the full WWTP scale.

### SUMMARY OF THE INVENTION

Embodiments of the present disclosure may include a device for obtaining and collecting foam from a foam-water interface and reducing the liquid content of said foam prior to collection, including one or more rotatable drums, wherein the surface of said one or more drums comprises material that is configured to collect foam from said foam-water interface upon contact of the drum with said interface, and to allow liquid present in the foam to drain through the surface of the drums and reduce the liquid content of the foam as the said one more rotatable drums rotate.

Further embodiments may further include a collection bin, where foam with reduced liquid content is collected. Others may include a blade to scrape foam off the surface of the drum. In yet others, a blade may be held at a distance from the drum to not contact the drum during operation but still be capable of scraping foam from the surface of the drum.

Other embodiments may include a suction device to collect the foam with reduced liquid content.

Some embodiments may include one rotatable drum or two rotatable drums. Some embodiments including two rotatable drums may further include a rotatable belt attached to itself at either end, located around and extending between both rotatable drums, where the belt comprises material that is configured to allow liquid present in the foam to drain through the surface of the belt, and where the two rotatable drums are configured to rotate in the same direction and rotate the belt in the same direction of rotation. Some embodiments may include a collection bin, wherein foam with reduced liquid content is collected, and/or a comprising a suction device to collect said foam with reduced liquid content.

Other embodiments may further include a motor capable of rotating the at least one rotatable drum. Others may further include a handle, allowing said at least one rotatable drum to be placed into and removed from the foam-liquid interface.

Embodiments of the present disclosure may include a device for obtaining and collecting foam from foam-liquid interfaces and reducing the liquid content of the foam prior to collection, including two rotatable drums, and a rotatable belt attached to itself at either end, located around and extending between both rotatable drums, where the belt includes material that is configured to collect foam from the foam-water interface upon contact of the drum with said interface, and to allow liquid present in the foam to drain through the surface of the belt, and wherein the two rotatable drums are configured to rotate in the same direction and rotate said belt in the same direction of rotation.

Aspects of the present disclosure may include methods for obtaining and collecting surfactant compounds from foam-liquid interfaces including: placing a device in contact with said foam-liquid interface, wherein the device includes one or more rotatable drums, where the surface of said one or more rotatable drums comprises material that is configured to collect foam from said foam-water interface upon contact of the drum with said interface and allow liquid present in the foam to drain through the surface of the drums and reduce the liquid content of the foam as the said one more rotatable drums rotate, wherein said device contacts said foam-liquid interface along a portion of said one or more rotatable drums; and rotating said one or more rotatable drums.

Other aspects may further include collecting said reduced liquid from the surface of one or more rotatable drums. In others, the device may include two rotatable drums, and further including a rotatable belt attached to itself at either end or otherwise continuous, located around and extending between both rotatable drums, wherein the belt includes material that is configured to allow liquid present in the foam to drain through the surface of the belt, and where the two rotatable drums are configured to rotate in the same direction and rotate the belt in the same direction of rotation, and wherein the reduced liquid foam is collected from the surface of the rotatable belt.

In others, the surfactant compound is selected from PFAS, PPCPs, proteins and/or enzymes, dyes, metal-containing compounds. In others, the surfactant compound comprises PFAS. In yet others, the foam-liquid interface is foam-effluent at a WWTP. In others, the foam is aerated using a cascade.

Yet other aspects further include orientating said device such that the two rotatable drum are orientated approximately vertically from each other, such that liquid draining from foam located on the rotating belt near the top of the device can drain through foam on the rotating belt lower down the device to drive further enrichment of surfactant compounds in the reduced liquid foam.

### BRIEF DESCRIPTION OF THE DRAWINGS

FIG. 1 is a photograph of the post-tertiary cascade at the KWRF where foams and foam collection devices of the present disclosure were tested;

FIG. 2 is a graph of surface tension and collection rates of foamate collected via passive overflow for 5, 10, 20, 30, 60 and 600 seconds, with the dashed line representing the average surface tension of two effluent samples;

FIG. 3 is a table of PFAS species concentrations, limits of detection (LOD) and limits of quantification (LOQ) for foam collected via passive overflow and in situ cascade foam;

FIG. 4 is a graph of PFAS concentrations for samples collected during continuous peristaltic pumping of liquids from passive foam collection device after 1 (CF-1), 5 (CF-5), and 10 minutes (CF-10);

FIG. 5 is an isometric diagram of an example mesh skimmer (shown without mesh) of the present disclosure;

FIG. 6 depicts a diagrammatic side view of the example mesh skimmer of FIG. 5;

FIG. 7 is an isometric diagram of an example mesh skimmer (shown with mesh) of FIG. 5 of the present disclosure;

FIG. 8 is a side view of the example mesh skimmer of FIG. 5 showing placement and direction of foam travel while in use;

FIG. 9 reports (a) the foam collection rates and (b) surface tension when the mesh-skimmer was rotated at 16, 43, 79, and 105 rpm;

FIG. 10 is a table of PFAS species and concentrations and limits of detection (LOD) collected via an example mesh skimmer of the present disclosure;

FIG. 11 reports average PFAS concentrations for all compounds above the limits of quantification (LOQ) in the effluent and foam collected via an example mesh skimmer of the present disclosure over 4 different speeds;

FIG. 12 reports average PFAS enrichment factors in foamate collected with the mesh-skimmer across 4 different rotational speeds;

FIG. 13 is a side view diagram of an example mesh-belt skimmer of the present disclosure;

FIG. 14 is an isometric view diagram of the example mesh-belt skimmer of FIG. 13;

FIG. 15 is a side view diagram of the example mesh-belt skimmer of FIG. 13 orientated in use collecting foam;

FIG. 16 reports (a) the foam collection rates and collected volume per surface area and (b) foamate surface tension when the mesh-belt speed was 0.39, 0.67, and 0.98 m/s;

FIG. 17 is a table of average concentrations, limits of detection (LOD), and limits of quantification (LOQ) of all 40 PFAS compounds for collected effluent and foam samples collected with tan example mesh-belt skimmer;

FIG. 18 reports enrichment factors for 13 PFAS compounds detected in both the effluent and foam collected by an example mesh-belt skimmer over 4 mesh-belt speeds;

FIG. 19 is a graph of average daily mass of collected PFAS per width of mesh-belt skimmer with a belt speed of 0.98 m/s. Error bars are +/−one standard deviation;

FIG. 20 depicts estimated PFAS removal percentages from effluent for three scenarios collecting foam with 15-, 20- or 25-meter widths of mesh-belt skimmer with a belt speed of 0.98 m/s;

FIG. 21 is a process flow diagram for removal of PFAS from wastewater utilizing cascade generated foams collected via the foam mesh-belt skimmer, and subsequent further enrichment and destruction of PFAS in collected liquids using conventional foam fractionation and destructive technologies before re-injecting the treatment water at the top of the cascade;

FIG. 22 is a graph of six PFAS compound concentrations plotted against surface tension for 37 foam samples collected from the post-tertiary-treatment foam by various methods (wet-foam sampler, passive overflow, mesh-skimmer, and mesh-belt skimmer);

FIG. 23 is table of PFAS concentration vs. surface tension exponential regression fit parameters.

### DETAILED DESCRIPTION OF THE INVENTION

Aspects and embodiments of the present disclosure describe novel foam collection systems and methods utilizing a mesh or mesh-belt skimmer to continuously harvest foam forming at the WWTP. The drainage and collapse of foam during transport on the mesh further enhance the enrichment of long-chain PFAS in the collected foamate, increasing waste storage capacity and reducing transport and ultimately treatment costs. Scoping calculations suggest that the current mesh and/or mesh-belt skimmer could be scaled up to collect sufficient foamate to effectively remove most long-chain PFAS from the wastewater. In addition to PFAS, other compounds of concern, such as common industrial surfactants and pharmaceuticals and personal care products (PPCPs), may also be enriched and removed in the process. The mesh and/or mesh-belt skimmers may have further applications in other large-scale foam fractionation processes, enhancing the enrichment of foamate collected from in-situ foam.

A strong negative correlation between PFAS concentrations and surface tension in foamates collected at the KWRF indicates that surface tension can serve as a plant-specific proxy for PFAS concentrations. Notably, polyfluorinated precursor compounds exhibit higher enrichment factors in foam compared to their perfluorinated transformation products, suggesting that foam fractionation may remove more PFAS if implemented prior to secondary treatment, where most transformations occur.

Example 1. Testing Site. Example aspects and embodiments were tested and all foam and effluent samples were collected from the Kalamazoo Wastewater Reclamation Facility (KWRF) located in Kalamazoo, MI. The KWRF receives an average of 105 million L/day of combined industrial (20%) and municipal (80%) wastewater, which it treats with primary screens and sedimentation, secondary activated sludge with addition of powdered activated carbon and biological nutrient reduction, followed by tertiary chlorination and sand filtration. Since 2018, KWRF has participated in the industrial pretreatment program initiative of Michigan Department of Environment, Great Lakes and Energy (EGLE), to identify and reduce influent sources of PFAS. KWRF complies with all current Michigan PFAS discharge regulations.

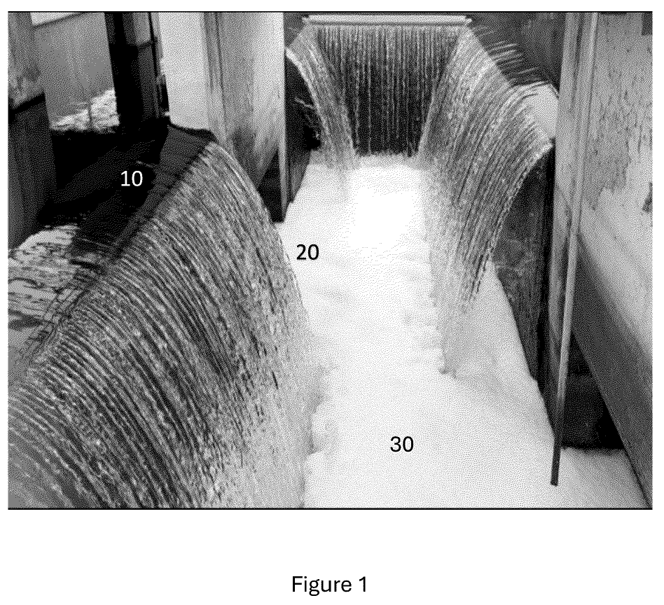

FIG. 1 is a picture of the cascade at the KWRF. Directly before the treated effluent 10 flows into the adjacent Kalamazoo River, it spills over a 2.4-m post-tertiary cascade 20 which generates a dynamic white foam 30. Foam samples were collected from the same location in the center of the post-tertiary foam for all three collection methods (described below) to precisely characterize surface tension and PFAS concentrations in the foam for better comparison across collection techniques. Effluent samples were collected directly up-gradient at the top of the cascade with a HDPE dipper on each sampling day.

Example 2. Passive foam overflow. Initially, to investigate PFAS concentrations in cascade foams at the KWRF, foam was harvested by allowing it to passively overflow into an 18.9 L HDPE bucket, which was weighed down with iron weights set in West Brand epoxy resin such that the internal volume was 13 L and empty density was 0.96 g/cm³ allowing it to sink into the underlying wastewater. The weighted bucket was suspended by a rope tied to a central anchoring pin such that the top was submerged 2 to 4 cm within the foam allowing it to flow freely into the void created by the bucket. Discrete foam samples were collected in triplicate by lowering the bucket in the foam for 5, 10, 20, 30, or 60 seconds before hoisting it out of the foam. Residual foam in the bucket completely collapsed ˜60-90 seconds after collection, leaving foamate (collapsed foam) collected inside the bucket. Samples were collected in a 1-L HDPE bottle and excessive volume was measured with a 4000 mL graduated cylinder.

Results from discrete samples indicate that liquid foamate continuously collects in the bucket while it is suspended in the unstable foam, which readily collapses during collection. Therefore, a drill-mounted peristaltic pump was used to continuously collect the accumulating liquid at the bottom of the bucket, pumping it up to the sampling deck at 2 L/min via HDPE tubing attached to the anchoring rod at the center of the bucket. Samples were collected in 1-L HDPE bottles from the pump after the weighted bucket collection device was submerged in the foam for 1, 5, and 10 minutes. The maximum pumping rate was exceeded by the rate of liquid accumulation in the bucket, as it was completely filled at the end of the sample collection. For comparison, the foam sampling device described in Coffin et al. (2024) was used to collect a composite sample (n=15) from the same location in the tertiary foam.

To investigate the maximum sustainable flow rate of liquid out of the collection device a 12-Volt Hurricane XL submersible pump was set at the bottom of the bucket to pump the collected liquid to the sampling deck. Foamate was continuously pumped at 6 increasing rates (0.32, 3.57, 6.09, 7.92, 9.13, and 11.1 L/min) for 15 minutes to investigate if the flow rate could be sustained. Samples were collected in 1-L HDPE bottles after 10 minutes of pumping. An effluent sample was collected directly up-gradient at the top of the cascade with a HDPE dipper on each of the three sampling days.

Analysis. For Example 2, as well as other Examples below, surface tension of all collected samples were measured using the Wilhelmy plate method with a CBVP-Z surface tensiometer (Kyowa Interface Science Ltd, Japan). Due to the dynamic nature of surfactants, multiple measurements were taken over the course of 15 minutes, ensuring a fresh initial surface by aliquoting immediately before taking the initial measurement. Values reported for a surface age of 15 minutes were used for equilibrium surface tensions. These measurements demonstrate the foamability of the wastewater and relative abundance of surfactants in foams, as they lowered surface tension. A subset of samples were sent to Enviro Lab Services, Inc., an external Michigan PFAS-certified laboratory, for quantification of 40 PFAS compounds via liquid chromatography with tandem mass spectrometry (LC/MS/MS) following the EPA 1633 method (EPA, 2023). Samples were subject to solid-phase extraction (SPE) prior to LC/MS/MS analysis.

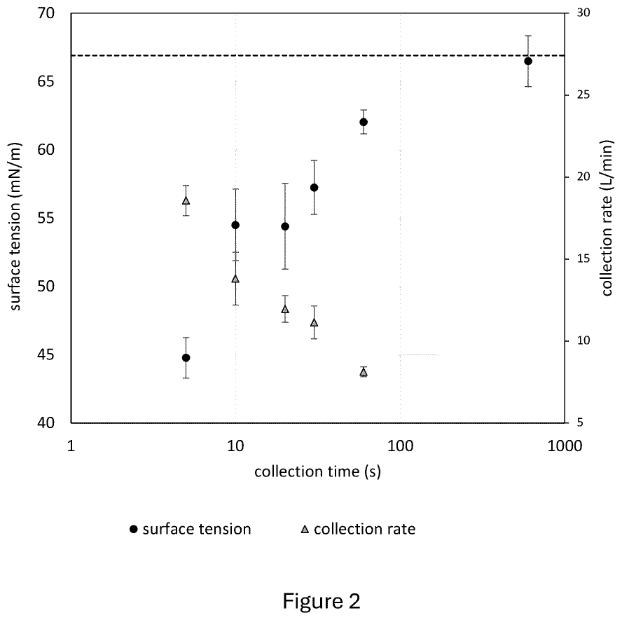

Results. Wet foam generated by the post-tertiary cascade at the KWRF readily flows into the passive overflow collection device when it is initially lowered into the foam. The internal volume of the device quickly became full of foam after only 5-10 seconds after which foam completely bridged the void space. FIG. 2 shows the calculated foamate flow rate (collected liquid volume/time) and surface tension of the passively collected foam. Surface tension and collection rates of foamate collected via passive overflow for 5, 10, 20, 30, 60 and 600 seconds. Values are reported as averages of triplicate samples (error bars+/−one standard deviation). The dashed line represents the average surface tension of two effluent samples. Foamate collection rates (triangles) decreased with increasing collection time. In contrast, surface tension (squares) increased with collection time, indicating a decrease in surfactant concentration.

During continuous foam collection, the device was always filled with foam as the rate of inflow exceeded the rate of foam collapse. Interestingly, after 5 minutes, collected foam consisted of visually larger bubbles and was rigid, appearing drier than the surrounding flowing wet foam. As the dry foam accumulated, it periodically was transported out of the device towards the cascade by flowing foam, however. Surface tension also increased with increasing collection time when foamate was collected with the peristaltic pump at 2 L/min, increasing similarly from 46.1 mN/m after 1 minute to 59.5 mN/m after 5 minutes to 59.8 mN/m after 10 minutes, only slightly below that of the effluent (63.8 mN/m). Greater surface tensions were also reported for samples collected with the submersible pump, which were taken over two hours while the collection device remained submerged in the foam, with surface tensions again similar to that of the effluent (66.4 mN/m).

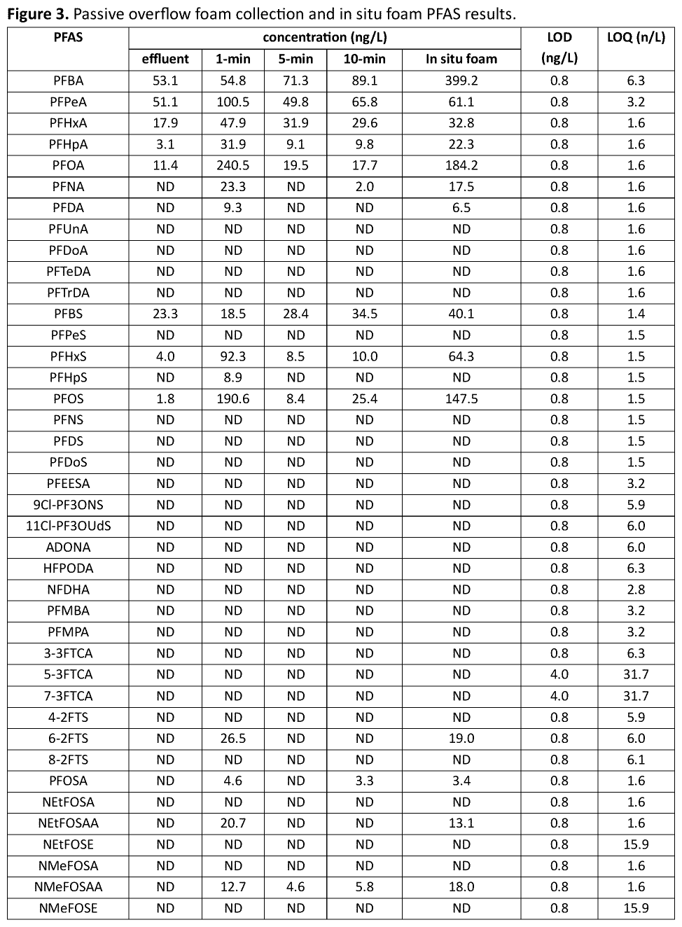

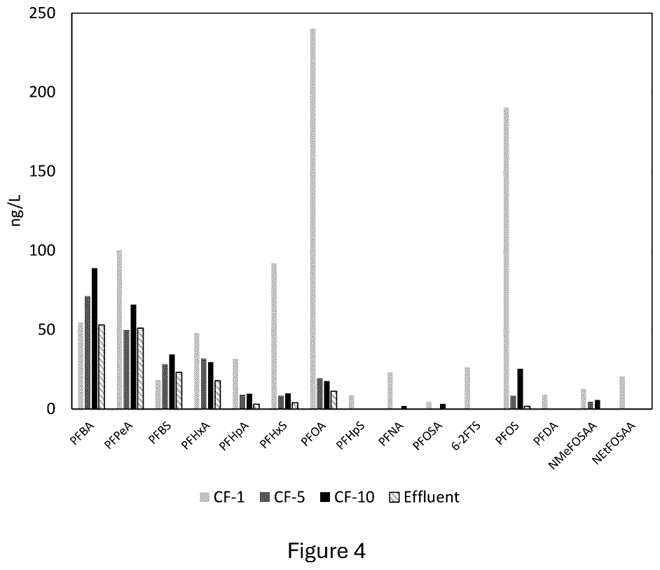

PFAS concentrations, limits of detection (LOD), and limits of quantification (LOQ) of all 40 PFAS compounds for collected effluent, the 3 foamate samples collected with the peristaltic pump, and in situ foam collected using the foam sampling device described in Coffin et al. (2024) are provided in the Table in FIG. 3. PFAS concentrations generally follow the same trend as surface tension, with total observed PFAS (140 compounds) decreasing from 883.1 ng/L (1 minute), 231.5 ng/L (5 minutes) and 293.0 ng/L (10 minutes), compared to 165.7 ng/L for the effluent and 1029 ng/L for the in situ foam. FIG. 4 reports the concentration of all detected PFAS in order of increasing molar volume from left to right for the three different collection times and effluent. Initially, higher molar volume PFHpA, PFHxS, PFOA, PFHpS, PFNA, PFOSA, 6-2 FTS, PFOS, PFDA, NMeFOSAA, and NEtFOSAA (>214 g/cm3) are much more concentrated in the foamate, decreasing over time with many compounds below detection limits in subsequent samples and the effluent. For example, the enrichment of PFOS relative to the effluent (1.8 ng/L) decreases from 103.5 (1 minute) to 4.56 (5 minutes) and 13.8 (10 minutes) and PFOA (11.4 ng/L in effluent) decreases from 21.1 (1 minute) to 1.72 (5 minutes) and 1.55 (10 minutes). In contrast, concentrations of lower molar volume PFBA, PFPeA, PFBS, and PFHxA (<186 g/cm3) are more constant over time, with concentrations more comparable to the effluent. Interestingly, the concentration of both PFBA and PFBS increase with continued collection time, reaching their highest concentrations after 10 minutes. Enrichment of PFBA (53.1 ng/L in effluent) increased from 1.03 (1 minute) to 1.34 (5 minutes) to 1.68 (10 minutes), while PFBS (23.3 ng/L in effluent) increased from 0.79 (1 minutes) to 1.22 (5 minutes) to 1.48 (10 minutes). With the exception of PFBA, the concentration of most PFAS are very similar between the in situ foam and foamate collected after 1 minute.

When foamate was collected from the passive overflow device with the submersible pump, all but the two highest flow rates were maintained during the 15 minute pumping period, with 9.1 and 11.1 L/min running dry within 10 minutes of continuous pumping. Therefore, it appears that the maximum sustainable flow the passive foam collection device can achieve is around 8 L/min, reaching an equilibrium where inflow of foamate generated by draining and collapsing foam matches that at which it is pumped out of the bottom. Based on the observed trends of increased surface tension and decreased enrichment of most PFAS with continued collection time, it is not appropriate to calculate mass flows with the available data.

In the context of the passive overflow collection device, retention of larger PFAS during foam drainage and collapse combined with the observed slow collapse time (˜90-120 second), decreased rate of foamate accumulation over time, and observed flow of dry foam out of the device during collection explain the decrease in PFAS concentration and increase in surface tension over time. Initially foam flows into the void space of the collection device at a greater rate than it collapses, causing foam to accumulate even as it continuously drains and collapses. Foam continues to rapidly accumulate until the device is filled with foam after ˜10 seconds. Once this occurs, the rate of foam flow into the device is volumetrically constrained by the rate of foam collapse inside. Therefore, foam-foamate flow rates calculated for 5 to 60 seconds of foam collection rapidly converge to the maximum sustainable flow rate of ˜8 L/min, indicating a steady state is reached between foam flow in and collapse.

While this explains the decrease in flow rate over time it cannot alone explain why the composition of collected liquids from the foam changes over time. However, PFAS and other surfactants partitioning during foam drainage and collapse has been demonstrated to be non-linear and likely controls their distribution during collection (Coffin et al., 2024). Initially when the collection device is not completely filled with foam, if all the collected foam is collapsed the foamate should have the same composition as the in situ foam, as there is nowhere else for the PFAS to go. Once the collection device is full, foam can bridge across and flow over the device. While there may not be room for the foam to flow into the device, liquid draining from the overlying foam can transport downward into the retained foam and eventually drain out at the bottom of the collection device. This additional liquid should be depleted in high molar volume PFAS as they are retained in the foam that transports out of the collection device. Therefore, the liquid collected at the bottom of the device during continuous collection is more representative of that which drains from the foam explaining why surface tension increases and PFAS concentrations decrease with increasing molar volume over time. This conceptual model is also supported by the relative increase in PFBA and PFBS with increasing collection time as these low molecular volume PFAS are expected to readily partition with the draining fluid.

Mesh-skimmer. To reduce issues with loss of foam and retention of drainage liquid, an example mesh skimmer was developed, which is designed to interact with the foam/water interface, collecting foam on a spinning drum made out of mesh to allow drying/draining of foam to reduce collection volume. Drum rotation speed may be adjustable to tailor collection rate to drainage speed, foam collapse rate once skimmed from the surface, and rate of foam formation and collapse in the cascade basin itself.

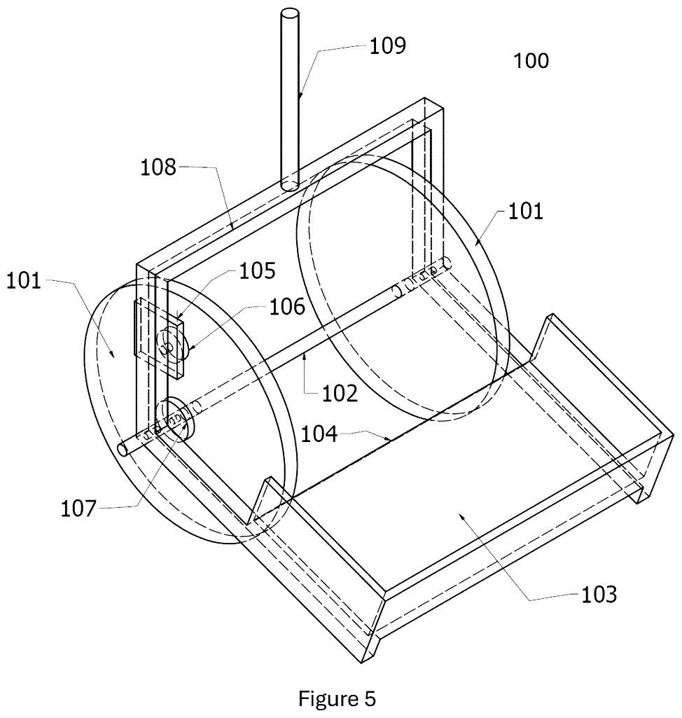

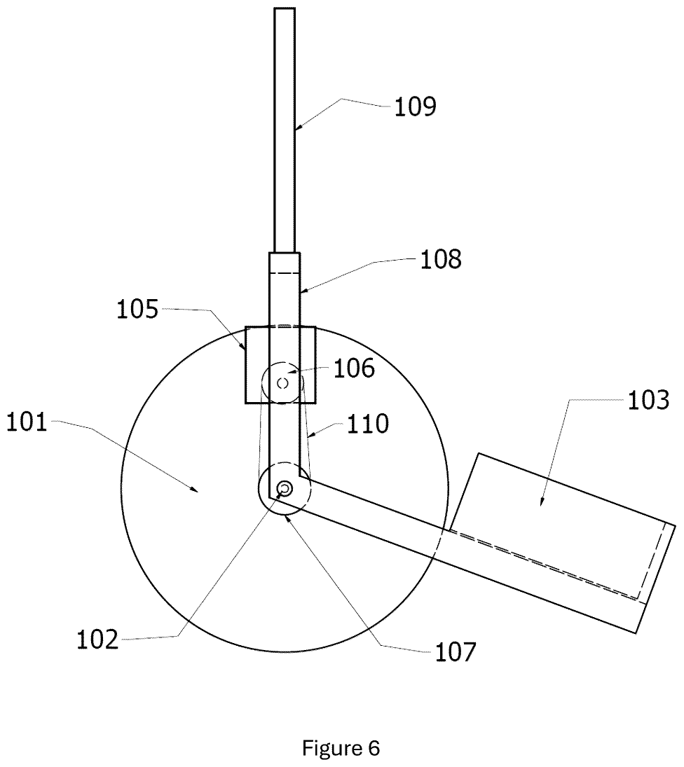

FIG. 5 is an isometric diagram of an example mesh skimmer 100 of the present invention, shown without a skimmer mesh and drive belts for clarity. Rotatable disks 101 form sidewalls of the rotating mesh-skimmer. In some embodiments, sidewalls may be comprised of metal, plastic, wood or similar materials. Sidewalls may be of various designs (e.g., solid or perforated, of a hub and spoke design, etc.) and thicknesses to optimize strength, reduce weight, resist water damage, and/or resist foam adhesion (so that more foam adheres to the skimmer mesh for removal). Similar concerns may drive the materials used of other parts in the embodiments and aspects here and below. Disks 101 may rotate around axel 102, with rotation driven by motor 105 attached to chain pulley 110 via belt (not shown; see FIG. 6) to shaft pulley 107. In some embodiments, a frame 108 attaches to axel and also holds a collection bin 103 in place adjacent to the rotating skimmer portion of the device 100. In some embodiments, scraper 104, used to harvest foam off of the skimmer mesh, may be an inward facing edge of bin 103 (i.e. the lower edge of bin 103 scrapes off the foam); in some other embodiments, a metal or plastic blade or other material, i.e. flexible rubber or latex) may be located at edge 104 or mounted slightly protruding from bin 103. It is expected that foam per se would not quickly wear down scraper 104; in some embodiments, water resistant materials may be chosen rather than a wear-resistant material. The device may be held in proper position in the foam or foam/water interface by pole 109. Other methods of holding the device 100 in place are possible, including extending or an attachment to axel 102.

FIG. 6 depicts a diagrammatic side view of the example mesh skimmer 100 of FIG. 5, shown without the skimmer mesh for clarity. Shown is axel 102, with rotation driven by motor 105 attached to chain pulley 106 via belt 110 to shaft pulley 107. Other means of rotation such a chain rather than drive belt, or other configurations are also possible. Motor 105, chain pulley 106 and shaft pulley 107 may be mounted in various places, but an interior face of the device 100 is shown here. Mounting on the inside face of frame 108 protects the drive components above from damage (such as against tank walls, etc.). Mounting on the outside face of the device 100 (such as on the outside of frame 108) may allow for some reduction of exposure of motor components to water from draining foam, although said components are expected to be somewhat water resistant in most embodiments: thus, motor 105 may be water-proof, water-resistant, etc. depending on the application.

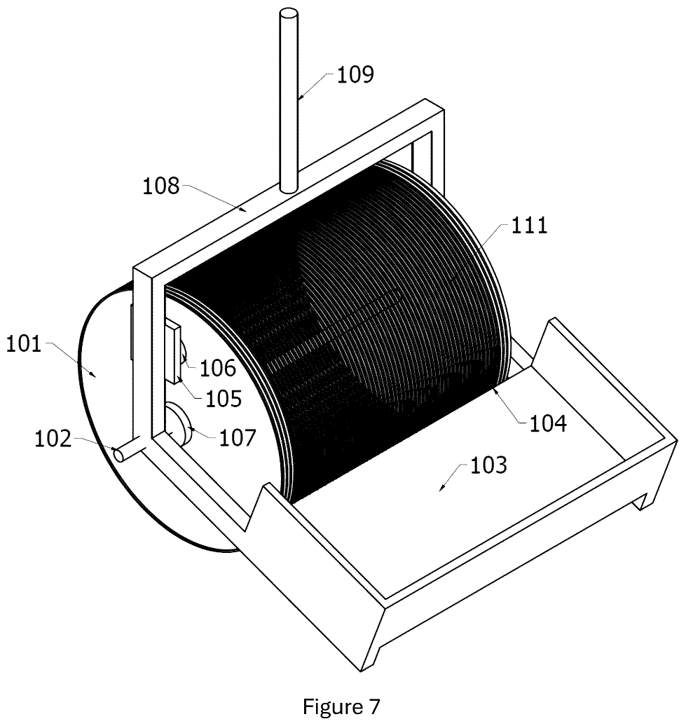

FIG. 7 depicts an isometric diagram of the example mesh skimmer 100 of the present invention, shown with the skimmer mesh 111. The mesh wraps around the entire skimmer drum, allowing foam to adhere to mesh 111 towards the back of the device 100 (in this orientation). Edge 104 is usually located on or a small (e.g., 0.5 cm) distance from the mesh 111 surface; a distance away from the rotating drum reduces friction and the need to change blades, but can be used flush to the mesh in some embodiments, for instance those mounting a flexible rubber or latex edge to help “squeegee” the foam off the surface of the drum. The foam, however in most applications usually has enough adhesion and bubble size to span a small gap between drum surface and edge 104.

Various conformations of the collection bin 103 are possible. In some embodiments, bin 103 is conformed and/or attached to the device such that the bottom of the bin or a portion thereof is sloped slightly downhill to allow further drainage of the foam. In some embodiments, foam may be pumped out of the bin from a hose or other collection device from above or below. In others, drainate may be collected from below, either to be returned to the wastewater source via a simple hole in the bottom of the bin, or to be collected if desired, for instance if the drainate is elevated in a particular contaminate. In some further embodiments foamate may be collected directly from the surface of the mesh via vacuum or pump device, or foamate may be collected from the bin from a vacuum or pump device for further concentration, collection and/or treatment.

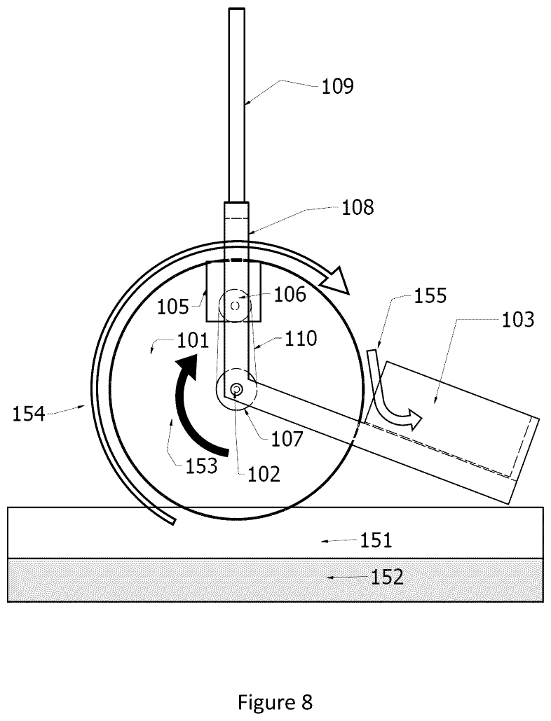

FIG. 8 depicts the travel clockwise (or counter-clockwise depending on orientation or rotation direction) as the mesh drum 111 rotates 153 toward the top of the device 100, allowing the adhered foam 154 to drain due to gravity, and then be scraped by edge 104 and deposited 155 into bin 103. Foam is collected with the mesh-skimmer once it is lowered 2-4 cm into the foam 151 overlaying the wastewater 152. The motor rotates the mesh cylinder, transporting foam which attaches to the mesh fabric up and around the mesh drum 111 until it is scraped off into the collection bin 103.

Example 3. Foam Collection using the Mesh Skimmer. Results from the passive overflow collection indicate a need for an active process to enable continuous collection while maintaining elevated PFAS enrichment factors. While testing various designs, it was discovered that wet foam readily attaches to mesh fabrics made from a variety of materials including fiberglass, aluminum, and galvanized steel. Therefore, two wooden disks (2.5 cm thick, 40 cm diameter) were wrapped with galvanized steel hardwire cloth (127 mm opening) forming a 46 cm long cylinder. A 16-mesh (15.5 mm opening) woven aluminum cloth was wrapped around the hardwire as smaller spacing was required for foam attachment. The cylinder was mounted on an aluminum axle housed in a wooden frame which was mounted on a steel rod so it could be lowered into the foam. A uxcell DC24V 80 W 160 rpm worm gear motor was used to rotate the axle via pulleys and a V-belt. The rotational velocity of the cylinder could be varied up to 105 rpm with an electronic motor speed controller. A flat piece of HDPE plastic was secured to the frame on one side of the cylinder leaving only a thin gap (0.5 cm) to scrape foam off the mesh as it rotated and collect in a HDPE container.

Foam samples were collected in triplicate by lowering the bottom of the mesh-skimmer 2-4 cm into the foam and rotating the cylinder at 16, 43, 79 and 105 rpm for 180, 30, 20 and 20 seconds, respectively. Collected foam was allowed to completely collapse in the HDPE container before pouring samples directly into 1-L HDPE bottles. Excessive volume was measured in a 1000 mL graduated cylinder.

Foam readily attached to the mesh-skimmer when it passed through the surface of the foam, blanketing the rotating cylinder with 2-3 cm of foam until being scraped off for collection. Interestingly, the mesh-skimmer was initially tested with just the galvanized steel hardwire cloth (127 mm opening) but the void space between the wires was seemingly too large for the films of the foam to span and did not readily attach to the mesh. Therefore, it appears foam attaches to the 16-mesh woven aluminum cloth (15.5 mm opening) because films can bridge the smaller void space, essentially incorporating the wires of the mesh in the foam structure.

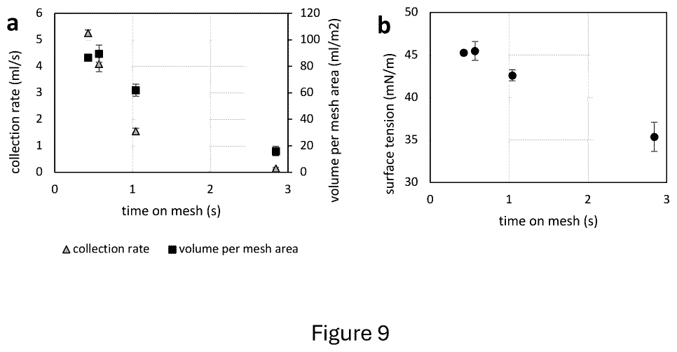

Faster rotational velocities correspond to shorter periods of foam travel time, i.e., time between when foam initially attaches to the mesh and is scrapped off for collection, and therefore foam is subject to less drainage and collapse. FIG. 9a reports the foam collection rates when the mesh-skimmer was rotated at 16, 43, 79, and 105 rpm corresponding to foam travel times of 2.8, 1.0, 0.57, and 0.43 seconds, respectively. As expected, collection rate decreased with increasing travel time (decreasing rotational velocity) as less mesh surface area passed the collection point per time. However, when collection rate was normalized to mesh surface area, the volume per surface area also decreased with increased travel time due to liquid loss during foam drainage and collapse. Surface tension also decreased with increasing travel time (FIG. 9b) indicating foam drainage and collapse on the mesh during collection enhanced enrichment of surfactants in the collected foam.

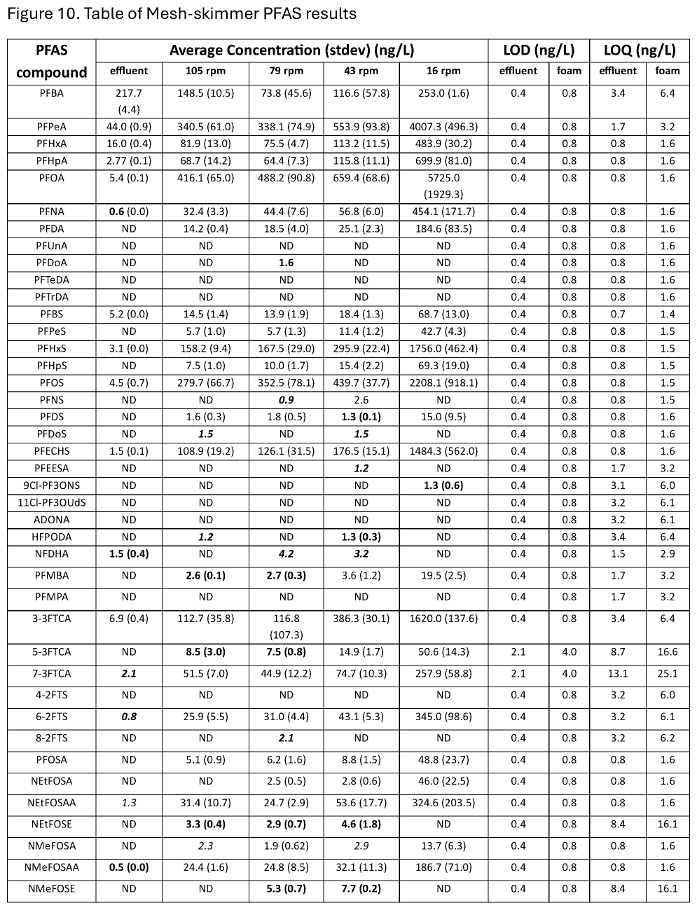

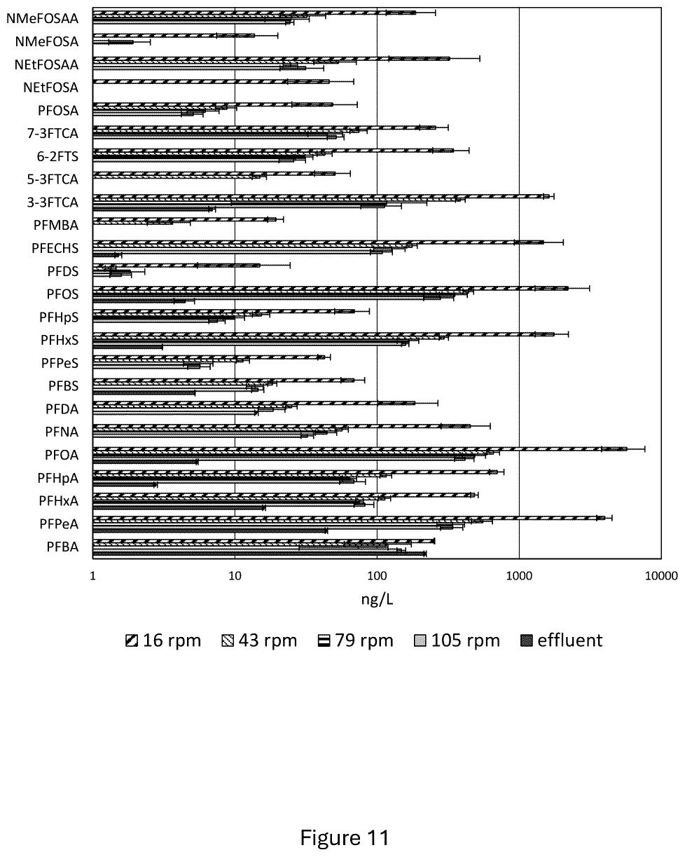

Average concentrations, limits of detection (LOD), and limits of quantification (LOQ) of all 40 PFAS compounds for collected effluent and foam samples are available in FIG. 10. Bolded values are estimated concentrations for compounds above the detection limit but under the limit of quantification. Values in italics were detected in only 1 sample but not in the corresponding duplicate (effluent) or triplicates (foam). Estimated values for three compounds in the effluent (NEtFOSAA, NMeFOSAA, and PFNA) were used to determine enrichment factors as these compounds were well above the LOQ in the foam. FIG. 11 reports average PFAS concentrations for all compounds above the LOQ in the effluent and foam collected via the skimmer over the 4 different speeds (error bars+/−one std. deviation). With the exception of PFBA, all PFAS concentrations are higher in the foam samples, specifically long chain PFAS compared to the effluent, which is dominated by short chain perfluoroalkyl carboxylic acids (PFCAs). Furthermore, 15 compounds detected across the foam samples, many of which are polyfluorinated precursor compounds, were not above the LOQ (12 non-detect) in the effluent indicating they became enriched in the foam from very low concentrations. In general, concentrations of PFAS in the foam increase slightly with decreasing rpm from 105 to 43 rpm (increasing travel time from 0.43 to 1.0 seconds). However, PFAS in foam collected at 16 rpm is much more concentrated, specifically in long-chain compounds.

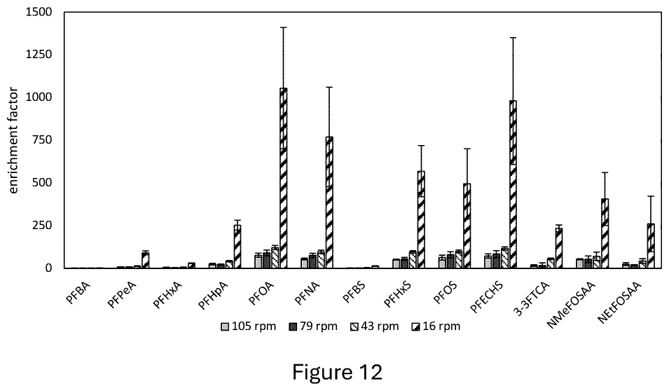

FIG. 12 reports calculated enrichment factors (foam concentration/effluent concentration) for 13 compounds detected in both the effluent and foam samples (error bars are +/−one std. deviation). Enrichment factors generally increase with PFAS molar volume across all 4 foam collection speeds as expected. However, enrichment factors of all compounds, except for PFBA, also increase with increasing foam travel time, with much larger enrichment factors for the longest travel time (2.8 seconds). The magnitude of this time-dependent increase in enrichment is greater for larger PFAS due to their retention during foam drainage and collapse; however, some short chain compounds also became further enriched. For example, the enrichment of PFOA increases from 77 (0.43 seconds of foam travel time) to 121 (1.0 seconds) to 1055 (2.8 seconds). In contrast, enrichment of PFBS and PFHxA only increase from 2.8 and 5.1 (0.43 seconds) to 3.5 and 7.1 (1.0 seconds) to 13.1 and 30 (2.8 seconds), respectively. These results show that enrichment of PFAS in foam, especially larger PFAS, can be intentionally increased by simply increasing the time which foam has to drain and collapse on the mesh before collection. To the best of our knowledge, this is the first time this phenomenon has been successfully exploited and demonstrated to enhance enrichment of PFAS (or any other surface-active compound) during foam collection.

Increasing enrichment factors in the collected foam has clear benefits when considering collection of cascade generated foam for removal of PFAS from wastewater. Greater PFAS enrichment requires less volume of foam be collected to remove the same mass from the wastewater, decreasing the liquid volume of foamate that would ultimately need to be treated. Given the scale of wastewater treatment plants even modest increases in enrichment can drastically decrease the foamate volume, which is critical as current destructive methods are cost prohibitive at large volumes (Ling et al., 2024; Meegoda et al., 2022). Therefore, the relative increase in enrichment from 105 rpm to 16 rpm for large PFAS such as PFHxS (11.1 times), PFOS (7.9 times), and PFOA (13.8) is extremely attractive when considering plants like the the KWRF average over 100 million liters per day. For example, the daily foamate volume necessary to remove 95% of PFOA from the effluent can be estimated by dividing the daily flow of wastewater (105,000,000 L/d) by the enrichment factor (105 rpm=77, 16 rpm=1055) and then multiplying by the percent removal (0.95). If the foam skimmer is run at 105 rpm, 1,300,000 L/d would need to be collected compared to only 95,000 L/d at 16 rpm, a decrease of 1,205,000 L/d. However, to allow sufficient time for foam drainage and collapse the rotational velocity of the skimmer was decreased resulting in a lower foam collection rate. Even though enrichment factors for large PFAS were increased substantially, the collection rate decreased by a factor of 36 resulting in less total mass collected per time. Furthermore, the mesh-skimmer only collects 460 L/d*m at 16 rpm, which would need to be scaled up to over 200 linear meters to collect 95,000 L/d rendering the required upscaling unreasonable given the dimensions of the cascade and receiving pool.

Results from the mesh-skimmer indicate increasing the time between when the foam attaches to the mesh and when it is collected increases enrichment of long chain PFAS and other surfactants but resulted in a decrease in collection rate as the rotation speed was lowered. Increasing the diameter of the cylinder would increase the time which foam is on the mesh while maintaining a greater collection rate as the foam travels more distance. However, a larger diameter cylinder would require a larger footprint, which may limit the ability to increase the scale of foam collection. However, the mesh-skimmer may be useful in situations with small collection areas, for sample collection purposes and the like.

Mesh-Belt Skimmer. To overcome some of the limitations of the mesh skimmer, a mesh-belt skimmer was constructed to increase the distance the foam travels on the mesh while minimizing the footprint within the foam. The mesh-belt skimmer was designed to simultaneously increase foam collection rate and travel time by increasing the distance foam travels on the mesh while minimizing the footprint in the foam.

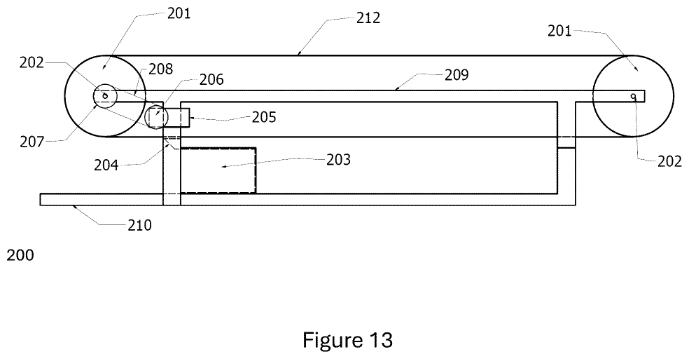

FIG. 13 depicts a diagrammatic side view of the example mesh-belt skimmer 200, shown with the skimmer mesh-belt 212. Shown are disks 201, axels 202, with rotation driven by motor 205 attached to chain pulley 206 via belt 208 to shaft pulley 207. Other means of rotation such a chain rather than drive belt, or other configurations are also possible. Motor 205, chain pulley 206 and shaft pulley 207 may be mounted in various places, but an interior face of the device 200 is shown here. Mounting on the inside face of frame 209 protects the drive components above from damage (such as against tank walls, etc.). Mounting on the outside face of the device 200 (such as on the outside of frame 209) may allow for some reduction of exposure of motor components to water from draining foam, although said components are expected to somewhat water resistant in most embodiments: thus, motor 205 may be water-proof, water-resistant, etc. depending on the application.

In use, foam travels over mesh belt 212, which is mesh to allow liquid drainage from the foam, and is scraped off belt 212 by blade 204 (which may be an edge of collection bin 203 in some embodiments). Foam is collected in bin 203 for removal of foam and/or further drainage of liquid from the foam. Pole 210 is used to hold the device in the foam in use, and allow it to be removed; in some embodiments, holder 210 may be attached to frame 209 or directly to one or more axels 202.

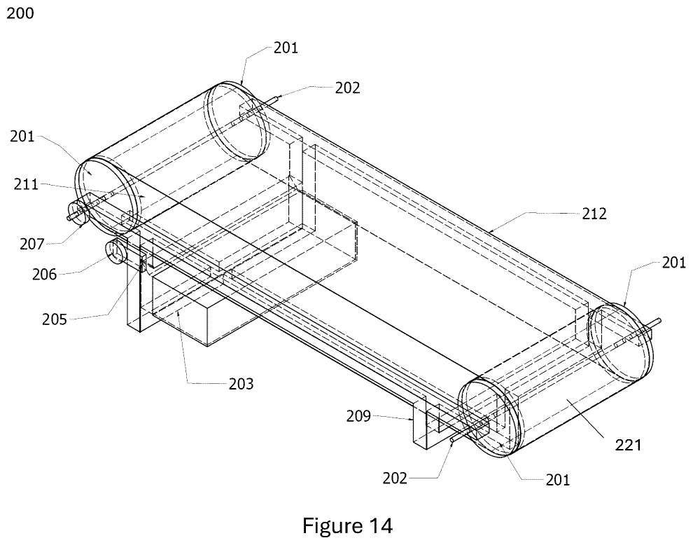

FIG. 14 shows an isometric diagram of an example mesh-belt skimmer 200 of the present invention, shown without drive belts for clarity. Rotatable disks 201 form sidewalls of the rotating upper mesh-drum 211 which drives the movement of the mesh-belt 212. Similarly, disks 201 form sidewalls of rotating lower mesh-drum 221. Lower mesh-drum 221 is rotated by the action of mesh belt 212 in most embodiments, although could have a separate motor, or separate belt attached to motor 205. An advantage of this embodiment of the mesh belt is that motor 205 may be mounted on upper drum 211, while lower drum 221 is in contact with the foam/water interface, keeping motor 205 farther from potential water damage from the interface.

In some embodiments, sidewalls may be comprised of metal, plastic, wood or similar materials. Sidewalls may be of various designs (e.g., solid or perforated, of a hub and spoke design, etc.) and thicknesses to optimize strength, reduce weight, resist water damage, and/or resist foam adhesion (so that more foam adheres to the skimmer mesh for removal). Similar concerns may drive the design of other parts in the embodiments here and below. Disks 201 may rotate around axel 202, with rotation driven by motor 205 attached to chain pulley 206 via belt (not shown; see FIG. 13) to shaft pulley 207. In some embodiments, a frame 209 attaches to axel and also holds a collection bin 203 in place adjacent to the rotating skimmer portion of the device 200. In some embodiments, scraper 204 (not shown; see FIG. 13), used to harvest foam off of the skimmer mesh, may be an inward facing edge of bin 203 (i.e. the edge of bin 203 scrapes off the foam); in some other embodiments, a metal or plastic blade or other material, i.e. flexible rubber or latex) may be located at edge 204 or mounted slightly protruding from bin 203.

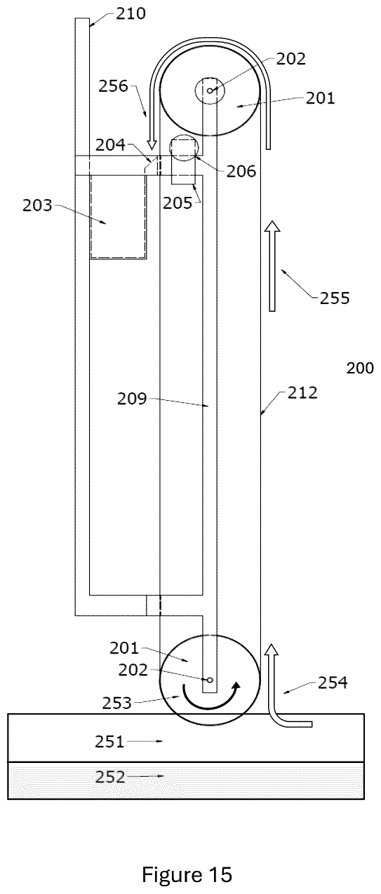

FIG. 15 depicts the travel clockwise (or counter-clockwise depending on orientation or rotation direction) as the mesh drum 211 once it is lowered 2-4 cm into foam 251 overlaying wastewater 252; drum 211 (and belt 212) rotates 253 toward the top of the device 200, allowing the adhered foam 254 on the mesh-belt 212 to transport vertically 255 and drain due to gravity, and then be scraped by edge 204 and deposited 256 into bin 203. The motor 205 rotates the mesh cylinder, which in turn drives movement of the mesh-belt, transporting foam which attaches to the mesh fabric until it is scraped off into the collection bin.

Example 4. Foam collection with Mesh-belt Skimmer. For further testing, a 2.9 m long by 0.39 m wide fiberglass 16-mesh belt (15.5 mm opening) was wrapped tightly around two 19 cm diameter rollers constructed by wrapping wooden disks with galvanized steel hardwire cloth such that the belt moved with the rotation of the rollers. The rollers were mounted 1.17 m apart on aluminum rods which served as axles mounted in a wooden frame which was attached to a steel rod so it could be lowered into the foam. One axle was driven by a uxcell DC24V 80 W 160 rpm Worm Gear Motor via pulleys and a V-belt while the other was left to rotate freely. An electronic motor speed controller allowed the belt speed to be varied up to 0.98 m/s. Foam attached on the belt was scrapped off by a thin piece of HDPE plastic which was placed flush against the mesh and collected in an HDPE container.

Foam samples were collected in triplicate by lowering the mesh-belt skimmer perpendicular to the foam surface such that the bottom roller was submerged in 2-4 cm of foam by running the belt at 0.39, 0.67, and 0.98 m/s for 120, 90 and 60 seconds respectively. Foam collected in the HDPE container was allowed to completely collapse in the HDPE container before pouring samples directly into 1-L HDPE bottles. Excessive volume was measured in a 4000 mL graduated cylinder.

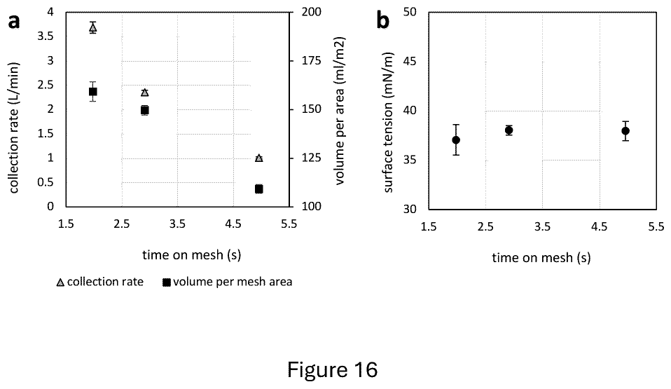

Similar to the mesh-skimmer, foam readily attached to the mesh-belt as it passed through the foam forming a 2-3 cm thick layer which transported vertically with the mesh until ultimately being scrapped off for collection. FIG. 16a reports the foam collection rates and collected volume per surface area of mesh when the mesh-belt speed was 0.39, 0.67, and 0.98 m/s corresponding to travel times of 5.0, 2.9, and 2.0 seconds respectively. As with the mesh-skimmer, increasing foam travel times decreased both the collection rate and volume per mesh area as liquid is lost through the mesh during foam drainage and collapse. However, foamate surface tensions remained consistent across all three belt speeds (FIG. 16b) indicating a maximum bulk surfactant enrichment may be achieved within 2 seconds of foam travel time. Interestingly, foamate volumes per mesh surface area were larger and varied less for the mesh-belt skimmer (110-160 ml/m²) compared to the mesh-skimmer (16-86 ml/m²) even though foam travel times were longer on the mesh-belt skimmer. This may be due to differences in the mesh material (aluminum vs. fiberglass), direction foam travels relative to gravity driven drainage (rotational vs. vertical), or how the foam was scrapped off the mesh (0.5 cm gap vs. no gap) but remains unclear.

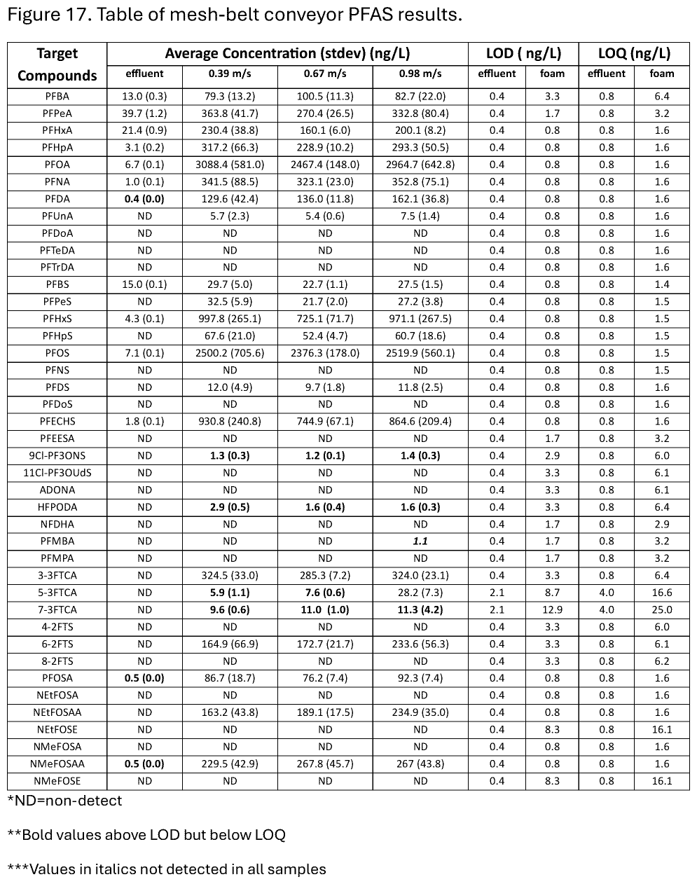

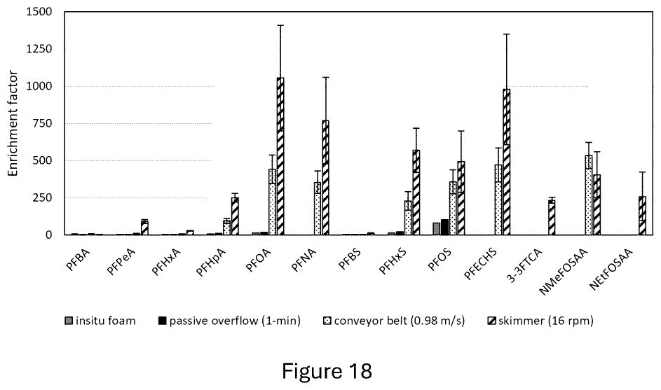

Average concentrations, limits of detection (LOD), and limits of quantification (LOQ) of all 40 PFAS compounds for collected effluent and foam samples collected with the mesh-belt skimmer are available in the table in FIG. 17. Bolded values are estimated concentrations for compounds above the detection limit but under the limit of quantification. Values in italics were detected in only 1 sample but not in the corresponding duplicate (effluent) or triplicates (foam). Estimated values for three compounds in the effluent (PFOSA, NMeFOSAA, and PFDA) were used to determine enrichment factors as these compounds were well above the LOQ in the foam. All detected PFAS concentrations were higher in the foam compared to the effluent, with 12 compounds only detected across the foam samples. FIG. 18 reports enrichment factors for the 13 compounds detected in both the effluent and foam collected over 4 mesh-belt speeds. As expected, long chain PFAS were more enriched in the foam than short chain due to their greater initial partitioning into the foam and retention during foam drainage and collapse. In contrast to the mesh-skimmer, PFAS concentrations were relatively consistent across the 3 belt speeds even though foam travel times ranged from 2.0 to 5.0 seconds. This may indicate a maximum enrichment is reached prior to 2 seconds of foam drainage and collapse on the mesh-belt as suggested from the surface tension above.

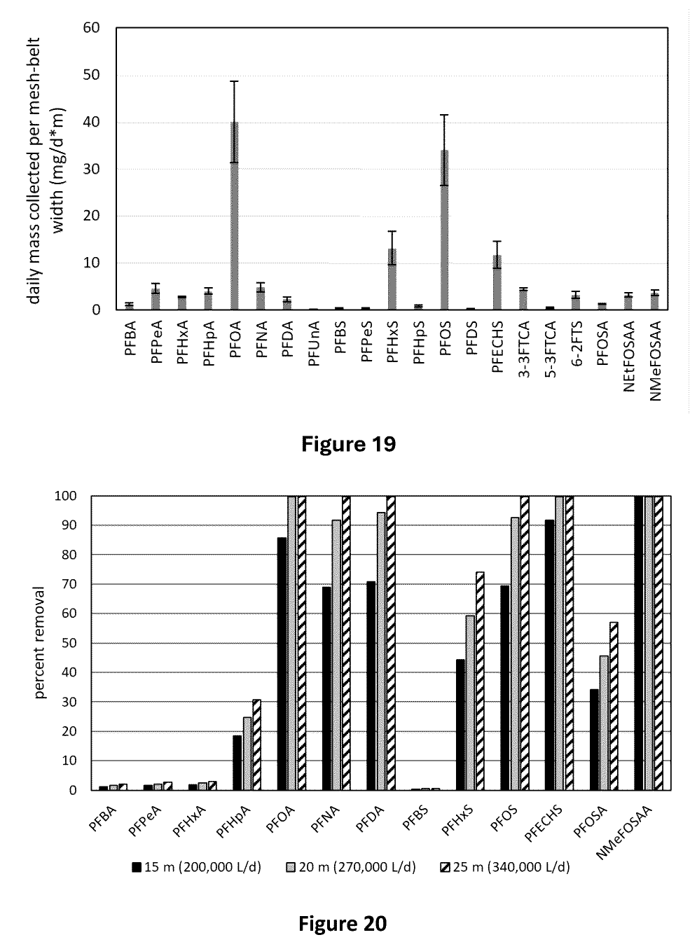

FIG. 19 compares PFAS enrichment factors for the in situ foam (composite collected with foam sampler), passive overflow foam collected in the first minute, mesh-belt skimmer at 0.98 m/s, and mesh-skimmer at 16 rpm to allow comparison across collection methods. In situ foam and passive overflow closely agree as both undergo no additional drainage or collapse during collection. Other existing foam collection methods, such as skimmers, are expected to perform similarly as they directly harvest the in situ foam. In contrast, the mesh-belt skimmer and mesh-skimmer are much more enriched as they actively promote foam drainage and collapse during collection. For example, PFHxS enrichment factors for the in situ foam (16) and that collected by passive overflow (23) increased by at least a factor of 10 in foam collected with the mesh-belt skimmer (230) and mesh-skimmer (570). While enrichment factors for many PFAS in foam collected with the mesh-belt skimmer operated at 0.98 m/s were about half that of the mesh-skimmer at 16 rpm, the collection rate per mesh width was 29 times greater for the belt (13,500 L/d*m) than the skimmer (460 L/d*m). The combination of high enrichment factors and foam collection rates make scaling up the mesh-belt skimmer for foam collection at the wastewater treatment plant scale more feasible than the two previous foam collection methods.

To demonstrate this, the average PFAS mass that could be collected per day per meter width of mesh-belt (mg/d*m) when ran at 0.98 m/s was calculated by multiplying the average concentration of each detected compound by the foamate collection rate (FIG. 19). PFAS mass per day in the effluent was then calculated by multiplying the concentration of each detected compound by the average daily flow (105,000,000 L/d). Three different scenarios are presented in FIG. 20 where the mesh-belt skimmer is scaled up to 15, 20, and 25 linear meters corresponding to collection of 200,000 L/d, 270,000 L/d, and 340,000 L/d of foamate. The cascade receiving pool where foam accumulates at the KWRF is 10.8 m by 2.44 m so the linear extent of the mesh-belt for all three scenarios could easily fit in the foam as 2-3 rows of 5-10-meter-long mesh-belt skimmers. Percent removals for each compound were estimated by dividing the mass in the foam for each scenario by the mass in the effluent per day. Using this calculation, estimated removal percentages for some compounds exceeded 100% signifying that more than enough foam volume would be collected. These values were capped by the observed enrichment factor as it represents an upper limit for percent removal (e.g. percent removal=100%*[1-1/enrichment factor]).

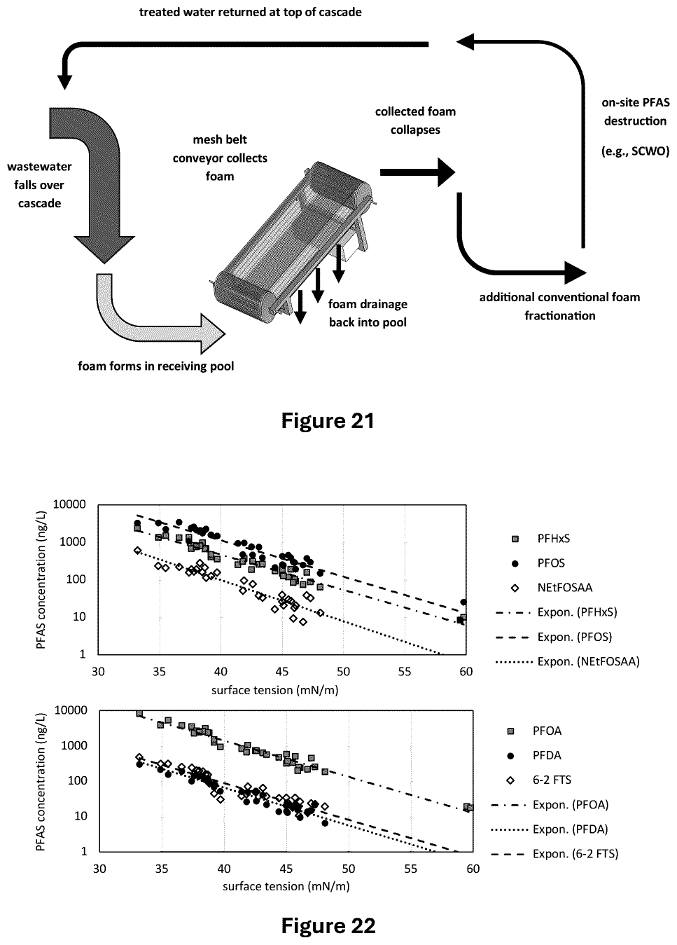

Considering the 20-meter scenario, PFOA, PFECHS, and NMeFOSAA are estimated to have over 99% removal from the effluent, with PFNA, PFDA, and PFOS over 90%, and even PFHxS and PFOSA over 40%. Importantly, similar removal percentages are expected for compounds detected in the foam with similar surface activity (comparable molar volumes) but were not detected in the effluent so removal could not be estimated. Given their low enrichment, short chain PFBA, PFPeA, PFHxA and PFBS are all under 5% removal and demonstrate current limitations of foam fractionation for collection of these compounds. Nonetheless, these calculations are highly encouraging as the majority of long chain PFAS would be removed from the effluent and concentrated in 270,000 L/d or 0.26% of the wastewater volume. For comparison, an estimated 900,000 L/d of foamate would need to be collected with the passive overflow to achieve 90% removal for PFOS, capturing only 20% PFOA and 22% PFHxS. Collecting more foam, such as the 25 meter scenario, increases the percent removal but also increases the volume of foamate requiring treatment. Alternatively, less foam can be collected, such as the 15 m scenario, at the cost of removing less PFAS from the effluent. An additional conventional foam fractionation process could be added to further concentrate long-chain PFAS in the collected foamate, further decreasing the volume prior to a destructive method such as SCWO, as described in the example treatment process in FIG. 21.

These scenarios make key assumptions such as the system is not limited by foam formation rates and enrichment factors remain constant over time. The KWRF cascade is estimated to generate well over 670,000 L/d of foamate (in situ) but it is unclear how this compares to the volume that could be collected with the mesh-belt skimmer. The only way to accurately access PFAS percent removal would be to conduct a pilot-scale study, continuously collecting foam using a larger mesh-belt skimmer over an extended period. Nonetheless, these initial calculations demonstrate the feasibility of removing long-chain PFAS at the WWTP scale by collecting highly enriched foam (relative to in situ foam) using the mesh-belt skimmer.

In summary, three foam collection methods were iteratively designed and evaluated for continuous collection of foam forming at a wastewater treatment plant cascade for removal of per- and polyfluorinated alkyl substances (PFAS). Surface tension and PFAS concentration of collected foamate and wastewater, along with foamate collection rates, were measured to assess their performance. Foam collection using a novel mesh skimmer and mesh belt skimmer increased PFAS enrichment over that of the in situ foam, as PFAS-depleted liquid can drain from the foam while it is on the mesh before it is scraped off for collection. The increased enrichment and the scalable foam collection rate provided by the mesh belt skimmer indicates most long-chain PFAS could be removed (>90%) and concentrated in 270,000 L/d of foamate or 0.26% of the wastewater volume. For comparison, an estimated 900,000 L/d of foamate would need to be collected with the passive overflow to achieve 90% removal for PFOS, capturing only 20% PFOA and 22% PFHxS. Limiting the volume of final collected foamate is critical as it requires additional treatment, which can be cost prohibitive at large volumes. While a pilot scale study is required to accurately assess removal percentages, the advantages provided by the mesh-belt skimmer may make foam collection for PFAS removal feasible at the full wastewater treatment plant scale.

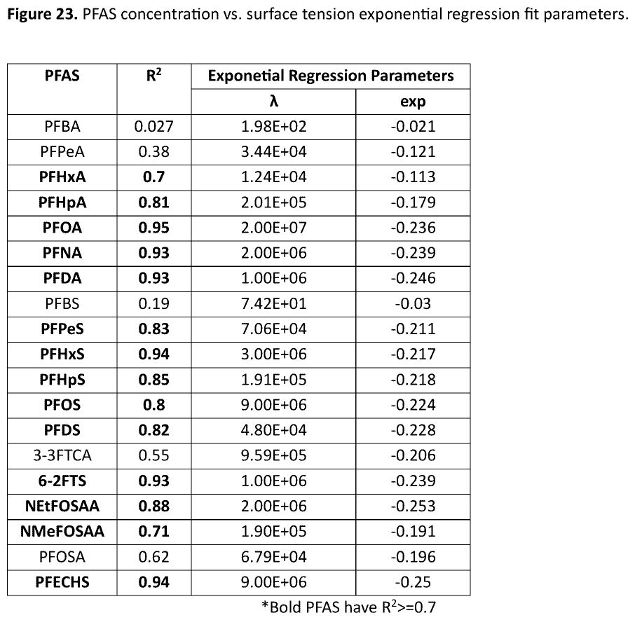

Example 5. Surface tension as proxy for PFAS enrichment. Recently, We et al. (2024a) demonstrated that surface tension of aqueous mixed liquor was negatively correlated with long chain PFAS enrichment in foams forming in secondary aeration tanks and may be an important parameter when assessing FF potential. Furthermore, surface tension of foamate has been demonstrated to be negatively correlated with surfactant enrichment, including PFAS, during foam drainage and collapse (Coffin et al., 2024). Given the log-linear relationship between surface tension and surfactant concentration below the critical micelle concentration (Lin, 1999), data for 37 foam samples collected from the post-tertiary foam at KWRF was compiled, regardless of how foam was collected (foam sampling device (insitu), passive overflow, mesh-skimmer, and mesh-belt), including data reported in Coffin et al. (2024). Then PFAS concentrations for compounds quantified in at least 20 samples were plotted against surface tension for each PFAS and fit with an exponential regression. Fits for select PFAS are reported in FIG. 22 and regression coefficient (R²), number of samples (n) and fitted parameter values for all compounds are reported in FIG. 23.

PFAS concentrations are strongly negatively correlated with surface tension (R²>=0.9) for PFOA, PFNA, PFDA, PFHxS, 6-2 FTS, and PFECHS. PFHpA, PFPeS, PFHpS, PFDS and NEtFOSAA also show strong negative correlation (R²>=0.8) with surface tension, while PFHxA, NMeFOSAA, and PFOSA are moderately negatively correlated (R²>=0.7). In contrast, short chain PFBA, PFPeA, and PFBS show no clear relationship with surface tension. These results agree with the conceptual model that decreasing surface tension across foam collected from the same location at the KWRF (assuming similar initial composition) is due to increasing surfactant enrichment during foam drainage and collapse. Therefore, concentrations of long chain PFAS are expected to increase with decreasing surface tension as they are retained in the foam while short chain PFAS partition with the draining fluid and show little to no correlation with surface tension.

Surface tension could even be used as a proxy for select PFAS concentrations, given the strength of the correlation once enough data has been collected to produce regression models like those in FIGS. 22 and 23. Concentrations estimated from surface tension would certainly have a large degree of error, even for compounds such as PFOA (R²=0.95), but can be obtained from a parameter that is cheap, easy, and quick to measure. Using surface tension as a proxy, the performance of a foam collection system can be assessed in real time allowing operational parameters to be optimized. Indeed, during development and testing of initial foam collection methods for this study, surface tension was used as a proxy for concentration to quickly rule out poorly performing methods, saving tens of thousands of dollars in analytical costs.

Example 6. PFAS transformations. Polyfluorinated precursor compounds have been demonstrated to transform in WWTP, following various pathways until ultimately forming per-fluorinated compounds (Eriksson et al., 2017; Helmer et al., 2022; Lenka et al., 2021). While the exact mechanisms of transformations remain unclear, they appear to be microbially mediated (LaFond et al., 2023). Transformation of precursors either occurring at the KWRF (in situ) or in samples after collection may impact interpreted enrichment factors and estimated removal percentages discussed above. Samples were immediately placed on ice after collection but may have been subject to transformations during transport to the external lab. Some of these precursors are included in the 40-analyte suite used in this study such as 3:3, 5:3, 7:3 FTCA and 4:2, 6:2, 8:2 FTS, which can transform to various PFCA with the same amount or fewer perfluorinated carbons (e.g., 5:3 FTCA has been shown to transform to PFHxA, PFPeA or PFBA but not PFHpA which has 5 perfluorinated carbons)(Butt et al., 2014). PFOSA, NEtFOSA, NEtFOSAA, NEtFOSE, NMeFOSA, NMeFOSAA, and NMeFOSE were also quantified which primarily transform to PFOS but may also form shorter perfluorosulfonic acids (Hamid et al., 2018).

The extent that any one precursor compound is transformed is difficult to constrain as there may be other similar but undetected precursor compounds present that can transform to either the detected precursor or the final perfluorinated compound. However, transformation of 5:3 FTCA and 6:2 FTS, both detected in the foam and associated with landfill leachate which the KWRF receives regularly, to PFPeA could explain why the enrichment factor for PFPeA (91) is over 3 times that of PFHxA (30.2) in foam collected with the mesh-skimmer at 16 rpm. If no transformations were occurring, the enrichment of PFPeA is expected to be considerably less than PFHxA, which is a longer and more surface-active compound. Furthermore, the corresponding concentration of PFPeA (44 ng/L) was 2.7 times higher than PFHxA (16 ng/L) in the effluent indicating an elevated source. If we assume the same extent of transformations occur in the effluent and foam samples, then the increase in PFPeA enrichment indicates precursor compounds (including 5:3 FTCA and 6:2FTS) become more enriched in the foam than their perfluorinated transformation products. If precursors had similar enrichment as PFPeA, then only the total mass of PFPeA would increase in both the effluent and foam but the enrichment would remain much lower.

Considering the molar volume of 5:3 FTCA (228 cm³) and 6:2 FTS (283 cm³) are much larger than PFPeA (158 cm³), and molar volume is positively correlated with drainage and collapse induced enrichment in foam (Coffin et al., 2024), it is not surprising that they may be more enriched in the foam. Furthermore, 6:2 FTS concentrations in foamate at the KWRF are more negatively correlated to surface tension (R²=0.93) than PFPeA (R²=0.38), an indication that 6:2 FTS behaves as a long chain PFAS. Enrichment factors for PFCAs with comparable molar volumes such as PFHpA (214 cm³) and PFNA (270 cm³) were 250 and 770, respectively. Given these values are much higher than the observed enrichment of PFPeA (91), the elevated enrichment of PFPeA could be explained with a simple mixing model with the lower expected enrichment of PFPeA (30) and high enrichment of precursors. Similarly, enrichment factors for 3:3 FTCA (200 cm³) were as high as 230, over 200 times that of a potential transformation product, PFBA (130 cm³). Enrichment factors for PFOA are also unexpectedly greater than larger PFAS, such as PFOS or PFNA in foam collected with the mesh-skimmer and mesh-belt skimmer, and may indicate similar contributions from unknown precursor compounds.

Therefore, it appears that FF could remove more total PFAS mass from WWTP if it occurs earlier in the treatment process, limiting precursor transformations to achieve higher enrichments. Specifically, FF could be placed before secondary treatment as most transformations occur there due to stimulated microbial activity (Lenka et al., 2021). If most long-chain PFAS are removed before the secondary, it may have the added benefit of significantly reducing PFAS concentrations in biosolids, limiting PFAS cycling between landfilled biosolids and landfill leachate received by WWTP (Stoiber et al., 2020). However, filamentous bacteria generate surfactants during secondary treatment (Collivignarelli et al., 2020; Palmer & Hatley, 2018) and may be a source of surfactants for foam formation to support FF. Therefore, additional study is needed to understand the source of surfactants in the foam generated at the KWRF cascade and assess if similar foam could be formed elsewhere in the plant. Additional surfactants could also be added, if necessary, with potential to tailor surfactant chemistry to help enhance enrichment of short chain PFAS to increase removal (Buckley et al., 2023).

Persons of skill in the art will realize that the above examples detail example embodiments and aspects and are provided to enable any person skilled in the art to practice the disclosure. The various modifications to these embodiments will be readily apparent to those skilled in the art, and the generic principles defined herein may be applied to other embodiments without the use of inventive faculty. Thus, the present disclosure is not intended to be limited to the embodiments shown herein but is to be accorded the widest scope consistent with the principles and novel features disclosed herein.

In some cases, the mesh belt and/or skimmer may be used in different configurations to fit the conformation of the site of use, for example, a shorter belt with a smaller basin or a steeper/shallower angle if collection basin walls are higher/lower. Other configurations are possible to account for needs for increased surfactant enrichment and/or collection rate, etc. For example, speeds may be increased on the mesh skimmer and mesh belt, up to the point where foam no longer adheres to the mesh to a suitable degree. Foam enrichment may be increased with keeping collection rates with increased lengths and speeds of the mesh belt. Notably, the maximum belt-speed at which foam will continually attach to the mesh is above 1 m/s as the fastest belt speed in this study (0.98 m/s) was not limited by foam availability. Therefore, the belt speed can be varied from 0 to >1 m/s to optimize foam collection rate for the desired application. Furthermore, variable angles of foam transport on the mesh are possible; foam drainage is driven by gravity and may have implications for surfactant enrichment in the collected foamate. If instead the mesh-belt moved at a 45-degree angle (from vertical), then liquid may more readily drain through the mesh, ultimately increasing enrichment of long chain PFAS. Foam only traveled vertically on the mesh-belt in Example 3, directly opposite the force of gravity, which may have limited the loss of liquid during foam drainage and collapse as it drains into the foam below instead of out the mesh to the pool below. The angle of foam transport can be varied freely to optimize foam drainage for the application.

Width of the belts may be driven by space considerations and other factors such as machine costs and maintenance time and cost. Devices with wider belts may be used to capture the entire foam layer in a particular basin, or multiple devices with narrower belts. Multiple devices may have the benefit of less down time overall and devices can be swapped out for maintenance as needed.

The influence of variable mesh material and size on foam drainage and collapse may play a key role in initial attachment of foam to the mesh and transport of draining liquid. For example, the mesh-skimmer was initially tested with just the 1% inch galvanized wire but the void space between the wires was seemingly too large for the films of the foam to span and therefore foam did not readily attach to the mesh. Therefore, a much smaller aluminum mesh was added as foam easily bridged the smaller void space and readily attached to the mesh. The performance of the mesh-belt skimmer may use a wide range of mesh sizes and materials depending on which promote foam attachment while also allow liquid to freely drain from the foam during transport. Mesh size and material may impact foam drainage as more liquid is expected to be retained in a hydrophilic mesh with small void spaces compared to a hydrophobic mesh with large voids. Possible mesh sizes could be anything smaller than 1%2 inch void spaces. Possible mesh materials include steel, aluminum, fiberglass, and plastics (HDPE, PET). The optimal size and material of the mesh will be dependent on the properties of the liquid and foam and therefore dependent on the application.

Foam may be scraped off the mesh for collection which may impact enrichment and collection rate, and various heights of gaps between the scraper and mesh are possible. Larger gaps between the mesh and the scrapper are expected to result in higher enrichment but lower collection rates as only the uppermost layer foam attached to the mesh would be collected. In contrast, the scrapper can be placed flush against the mesh to collect all foam, resulting in decreased enrichment but increased collection rate. The gap between the mesh and the scrapper can be varied to any distance between 0 mm (flush) to the height of the foam on the mesh to optimize the application. Other methods to collect the foam from the mesh are possible such as using a vacuum

Collection of WWTP foam with the mesh-belt skimmer has been demonstrated as a promising PFAS removal technology because PFAS are enriched in the collected foamate due to their surface activity. Other surfactants present in the wastewater will also become enriched in the foam and therefore also removed with the collected foam. There must be other surfactants present in the foam collected at the KWRF as the total concentration of observed PFAS (pg/L) is well below that required to explain the low foamate surface tension alone (mg/L) (Guo et al., 2023). WWTP are known to contain many different types of manufactured surfactants which they receive from a wide range of industrial and municipal sources (Palmer & Hatley, 2018). The global market for surfactants has rapidly expanded over the past few decades resulting in increased loads to WWTP and the environment, as not all surfactants are removed in typical WWTP processes (Freeling et al., 2019; Palmer & Hatley, 2018). This is concerning, as many commonly used surfactants have been demonstrated to negatively impact human health and the environment (Palmer & Hatley, 2018). Enrichment factors and corresponding percent removal are expected to be compound-specific, as with varying length and composition of PFAS, depending on their affinity for the foam. A limited number of studies have identified concentrations of specific surfactants in WWTP but many of the frequently detected compounds have long hydrocarbon tails (>C10) and high molar volumes indicating they will be highly enriched in the foam (Palmer & Hatley, 2018).

Recently, pharmaceutical and personal care products (PPCPs) have been identified as a class of emerging contaminants in WWTP. Given that many of these compounds are surfactants they have been demonstrated to become enriched in foam (Burzio et al., 2024) and may also be in foam collected at WWTP. Furthermore, high removal rates of microplastics have been demonstrated during dissolved air flotation at WWTP as they are hydrophobic and adsorb onto the air bubbles (Monira et al., 2023). FF is used to remove particulate matter as it can become trapped in the foam structure, such as bacteria removal in recirculating aquaculture systems (Brambilla et al., 2008), and therefore collection of WWTP foam may also remove microplastics.

In conventional column FF processes, foam drainage time can be increased to increase surfactant enrichment by either increasing the height of the column or decreasing the rate of foam formation (Burghoff, 2012; Merz et al., 2011; Wang et al., 2023). Foam height is inversely related to column diameter, making it difficult to scale up while maintaining surfactant enrichment in collected foamate (Kown, 1971). In contrast, the mesh-belt skimmer separates foam drainage from foam formation, providing a novel foam collection method that is scalable, increases surfactant enrichment during collection and can be fitted to many different tank sizes and geometries, a limitation of current foam collection methods as pointed out by We et al. (2024b). Given these advantages, the mesh-belt skimmer could have applications for foam collection in any large-scale FF process, not just for PFAS or other surfactant removal at WWTP. FF has many industrial applications such as protein and enzyme separation in the food and pharmaceutical industries (Burghoff, 2012), metal extraction in mining (Rangarajan & Sen, 2013), as well as dye recovery in the textile industry (Lu et al., 2010). If the mesh-belt skimmer can increase enrichment of these compounds in collected foamate over that of the in situ foam, as demonstrated with PFAS in the WWTP foam (PFOA 27 times more enriched), then it would have immense economic implications given the scale of these processes. Also, the cost to build, install, and operate the mesh-belt skimmer is expected to be minimal, as it can easily be retrofitted into existing infrastructure.

Collection of WWTP foam may also remove many other surface active compounds that are expected to also be enriched in the foam. The mesh-belt skimmer may also have applications in other large scale foam fractionation systems, as it can be easily retrofitted into existing industrial processes and provide increased enrichment of surface-active compounds in collected foamate.

What is claimed is:

1. A device for obtaining and collecting foam from a foam-water interface and reducing the liquid content of said foam prior to collection, comprising
one or more rotatable drums, wherein the surface of said one or more drums comprises material that is configured to collect foam from said foam-water interface upon contact of the drum with said interface, and to allow liquid present in the foam to drain through the surface of the drums and reduce the liquid content of the foam as the said one more rotatable drums rotate.

2. The device of claim 1, further comprising a collection bin,
wherein said foam with reduced liquid content is collected.

3. The device of claim 2, further comprising a blade to scrape foam off the surface of the drum.

4. The device of claim 3, wherein said blade is held at a distance from the drum to not contact the drum during operation but still be capable of scraping foam from the surface of the drum.

5. The device of claim 2, comprising a suction device to collect said foam with reduced liquid content.

6. The device of claim 1, comprising one rotatable drum.

7. The device of claim 1, comprising two rotatable drums, and further comprising a rotatable belt attached to itself at either end, located around and extending between both rotatable drums,
wherein said belt comprises material that is configured to allow liquid present in the foam to drain through the surface of the belt, and wherein said two rotatable drums are configured to rotate in the same direction and rotate said belt in the same direction of rotation.

8. The device of claim 7, further comprising a collection bin, wherein foam with reduced liquid content is collected.

9. The device of claim 8, further comprising a suction device to collect said foam with reduced liquid content.

10. The device of claim 1, further comprising a motor capable of rotating said at least one rotatable drum.

11. The device of claim 1, further comprising a handle, allowing said at least one rotatable drum to be placed into and removed from the foam-liquid interface.

12. A device for obtaining and collecting foam from foam-liquid interfaces and reducing the liquid content of said foam prior to collection, comprising
two rotatable drums, and
a rotatable belt attached to itself at either end, located around and extending between both rotatable drums,
wherein said belt comprises material that is configured to collect foam from said foam-water interface upon contact of the drum with said interface, and to allow liquid present in the foam to drain through the surface of the belt, and wherein said two rotatable drums are configured to rotate in the same direction and rotate said belt in the same direction of rotation.

13. A method for obtaining and collecting surfactant compounds from foam-liquid interfaces comprising:
placing a device in contact with said foam-liquid interface, wherein said device comprises one or more rotatable drums, wherein the surface of said one or more rotatable drums comprises material that is configured to collect foam from said foam-water interface upon contact of the drum with said interface and allow liquid present in the foam to drain through the surface of the drums and reduce the liquid content of the foam as the said one more rotatable drums rotate, wherein said device contacts said foam-liquid interface along a portion of said one or more rotatable drums; and
rotating said one or more rotatable drums.

14. The method of claim 13, further comprising collecting said reduced liquid from the surface of one or more rotatable drums.

15. The method of claim 13, wherein said device comprises two rotatable drums, and further comprising
a rotatable belt attached to itself at either end, located around and extending between both rotatable drums,
wherein said belt comprises material that is configured to allow liquid present in the foam to drain through the surface of the belt, and wherein said two rotatable drums are configured to rotate in the same direction and rotate said belt in the same direction of rotation, and wherein said reduced liquid foam is collected from the surface of the rotatable belt.

16. The method of claim 13, wherein said surfactant compound is selected from PFAS, PPCPs, proteins and/or enzymes, dyes, metal-containing compounds.

17. The method of claim 13, wherein said surfactant compound comprises PFAS.

18. The method of claim 17, wherein said foam-liquid interface is foam-effluent at a WWTP.

19. The method of claim 18, wherein said foam is aerated using a cascade.

20. The method of claim 15, further comprising orientating said device such that the two rotatable drum are orientated approximately vertically from each other, such that liquid draining from foam located on said rotating belt near the top of the device can drain through foam on said rotating belt lower down the device to drive further enrichment of surfactant compounds in said reduced liquid foam.
